(19) United States
(12) Patent Application Publication
(10) Pub. No.: US 2005/0053744 A1
(43) Pub. Date: Mar. 10, 2005

(54) Clean release card form and method of manufacture

(76) Inventor: Stanley C. Chess, Goffstown, NH (US)

Correspondence Address: NIXON & VANDERHYE, PC, 1100 N GLEBE ROAD, 8TH FLOOR, ARLINGTON, VA, 22201-4714, US

(21) Appl. No.: 10/654,466

(22) Filed: Sep. 4, 2003

(51) Int. Cl. B32B 9/00; B32B 33/00

(52) U.S. Cl. 428/40.1; 428/136; 156/250

(57) ABSTRACT

A clean release card business form is simplified in construction utilizing a clean release liner. The business form includes a web of base material having a top surface and a bottom surface. The clean release liner is affixed on the bottom surface. At least one die cut section is formed in the base material web top surface, which die cut section defines a corresponding removable clean release card. Indicia may be printed as desired on either or both of the top and bottom surface of the base material web. The base material web may be suitable for lamination or pre-laminated prior to die cutting the integrated clean release card.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates generally to business forms and, more particularly, to a clean release card business form including an integrated and removable card for identification or the like.

There are many uses for cards such as identification cards, and it is becoming increasingly popular in the manufacture of business forms to mount one or more cards on a form that is mailed to a recipient. In the construction of such forms, it is desirable to be able to use the form with both impact and non-impact printers (such as laser printers) with minimum amount of difficulties, and to be able to print the card with variable information on both the top and bottom faces thereof.

Conventionally, cards may be adhered to business forms using an adhesive, which often unattractively appears through the back of the card after it has been removed from the business form. Additionally, the use of adhesive undesirably generates some residual adhesive material after the card is removed from the form, which adhesive could remain on the card requiring the recipient to remove the adhesive.

### BRIEF SUMMARY OF THE INVENTION

It would thus be desirable to construct a clean release card form that is easy to manufacture and can be readily printed using impact or non-impact printers while including at least one integrated clean release card on the form. The present invention takes advantage of a clean release liner to simplify the clean release card form and utilizes a web of base material that itself is suitable for the clean release card.

In an exemplary embodiment of the invention, a method of manufacturing a clean release card form includes the steps of (a) supplying a web of base material having a top surface and a bottom surface; (b) printing indicia as desired on at least one of the top surface and the bottom surface; (c) affixing a clean release liner on the bottom surface; and (d) die cutting at least one section of the base material web top surface to define a corresponding at least one removable clean release card.

Step (a) may be practiced by supplying a web of pre-laminated base material, or by supplying a web of base material that is suitable for lamination. In a similar context, the method may further include, prior to step (c), the step of laminating one of both of the top surface and the bottom surface.

The clean release liner may be applied in a continuous press run or patched on the bottom surface adjacent the at least one section of the base material web top surface.

Step (d) may be practiced by die cutting a plurality of sections of the base material web top surface to define a corresponding plurality of removable clean release cards.

The method may additional include, prior to step (c), the step of applying an adhesive to at least one section of the base material web bottom surface to define a corresponding at least one adhesive area, where the adhesive area is smaller than and within an area of the clean release card; and after step (c), the step of die cutting the clean release liner around the adhesive area defining a liner portion, such that when the clean release card is removed from the form, the liner portion of the clean release liner remains attached to the clean release card.

In another exemplary embodiment of the invention, a clean release card business form includes a web of base material having a top surface and a bottom surface, a clean release liner affixed on the bottom surface, and at least one die cut section of the base material web top surface. The at least one die cut section defines a corresponding at least one removable clean release card.

In still other exemplary embodiments of the invention, a clean release card form is assembled according to the method of the invention, and an identification card mailer is assembled according to the method of the invention.

### BRIEF DESCRIPTION OF THE DRAWINGS

These and other aspects and advantages of the present invention will be described in detail with reference to the accompanying drawings, in which:

FIG. 1 is a plan view of an exemplary clean release card form according to the present invention;

FIG. 2 is a cross section of the clean release card form shown in FIG. 1;

FIG. 3 is a cross section of an alternative embodiment clean release card form; and

FIG. 4 is still another alternative embodiment of the clean release card form.

### DETAILED DESCRIPTION OF THE INVENTION

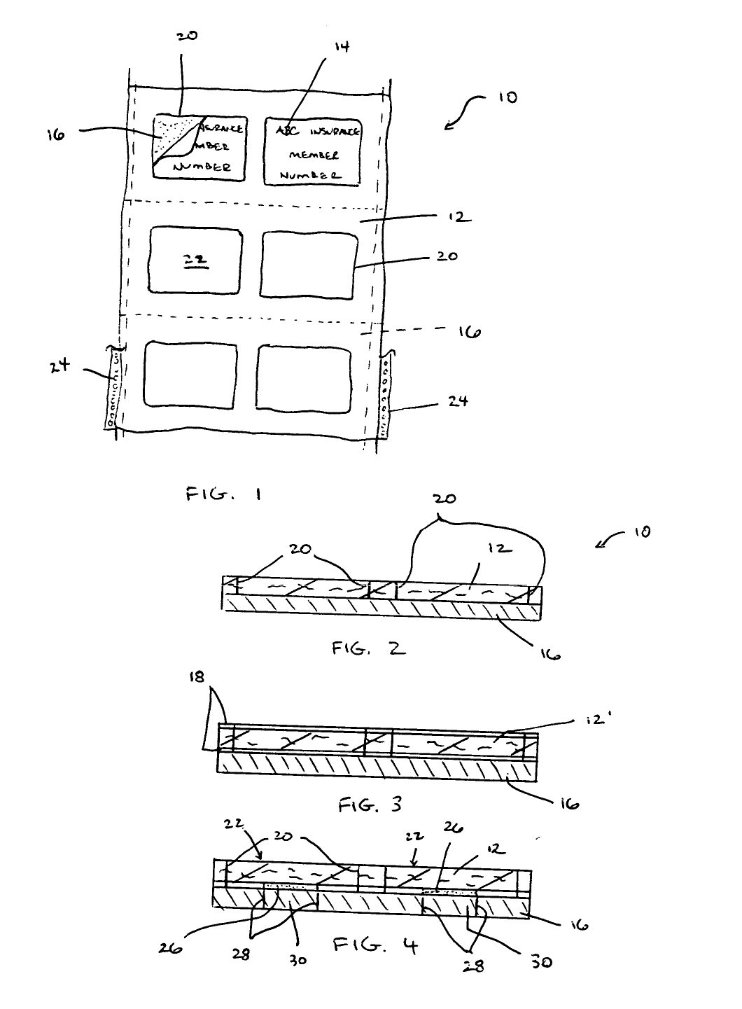

With reference to FIGS. 1 and 2, the clean release card form 10 of the present invention is generally constructed of a web of base material 12 having a top surface and a bottom surface. Indicia 14 may be printed as desired on either or both of the top surface and the bottom surface. A clean release liner 16 is affixed on the bottom surface of the base material web 12. After affixing the clean release liner 16, one or more sections of the base material web 12 top surface can then be die cut at 20 to define one or more corresponding removable clean release cards 22. The base material web 12 may be provided with perforated strips with apertures 24 therein for receiving a printer driving mechanism.

The base material web may be any of several suitable materials for the described purpose. One preferred material is a known paper-plastic-paper composite that is readily printable as desired. This known material without further processing is suitable for identification cards or the like for a clean release card business form product. Of course, other base material web products may also be suitable. For example, with reference to FIG. 3, a paper base product 12′ may be pre- or post-print laminated with a suitable laminate material 18 such as polyester or the like. The laminate 18 may comprise a layer having a thickness between 0.5 mil and 1 mil.

The liner is a paper or plastic/poly material that has been coated with a repositionable adhesive. A primer coat may be applied to the liner before the repositionable adhesive to enhance the adherance of the repositionable adhesive to the liner sheet. The repositionable adhesive will adhere to the liner sheet and not transfer to other materials that it comes in contact with. Although those of ordinary skill in the art will appreciate other suitable clean release liner products, a preferred product is sold by the assignee of the present invention under the trademark CLEAN-TAC™.

The clean release liner 16 may be affixed in any suitable manner in a continuous press run using known means or via a known patching process such that only portions of the bottom surface adjacent the die cut sections 20 of the top surface of the base material web 12 have the liner 16 applied thereto. Using a patching process for the clean release liner 16 would help to conserve the use of the clean release liner material.

FIG. 4 illustrates an alternative embodiment of the present invention. In this embodiment, before affixing the clean release liner 16 on the bottom surface of the base material web 12, an adhesive 26 is applied to one or more sections of the bottom surface of the base material web 12 to define an adhesive area. As shown in FIG. 4, the adhesive area defined via adhesive 26 is smaller than and within an area of the clean release card 22. Subsequently, after affixing the clean release liner 16 on the bottom surface, the clean release liner 16 is die cut at 28 around the adhesive area defining a liner portion. Consequently, when the clean release card 22 is removed from the form 10, the liner portion 30 of the clean release liner 16 remains attached to the clean release card 22. With this construction, the back of the clean release card 22 can be variable imaged.

With the construction of the clean release card form of the present invention, the form can be suitably printed using an impact or non-impact printer (such as a laser printer) for use as an identification card mailer or other clean release card form. By using a clean release liner, no adhesive residue results from removing the cards from the mailer. The simplified construction is easier and less expensive to manufacture than conventional constructions.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of manufacturing a clean release card form, the method comprising:
(a) supplying a web of base material having a top surface and a bottom surface;
(b) printing indicia as desired on at least one of the top surface and the bottom surface;
(c) affixing a clean release liner on the bottom surface; and
(d) die cutting at least one section of the base material web top surface to define a corresponding at least one removable clean release card.

2. A method according to claim 1, wherein step (a) is practiced by supplying a web of pre-laminated base material.

3. A method according to claim 1, wherein step (a) is practiced by supplying a web of base material that is suitable for lamination.

4. A method according to claim 1, wherein step (c) is practiced by applying the clean release liner in a continuous press run.

5. A method according to claim 1, wherein step (c) is practiced by patching the clean release liner on the bottom surface adjacent the at least one section of the base material web top surface.

6. A method according to claim 1, wherein step (d) is practiced by die cutting a plurality of sections of the base material web top surface to define a corresponding plurality of removable clean release cards.

7. A method according to claim 1, further comprising, prior to step (c), the step of laminating at least one of the top surface and the bottom surface.

8. A method according to claim 7, wherein the laminating step comprises laminating both of the top surface and the bottom surface.

9. A method according to claim 1, further comprising:
prior to step (c), the step of applying an adhesive to at least one section of the base material web bottom surface to define a corresponding at least one adhesive area, the adhesive area being smaller than and within an area of the clean release card; and
after step (c), the step of die cutting the clean release liner around the adhesive area defining a liner portion, such that when the clean release card is removed from the form, the liner portion of the clean release liner remains attached to the clean release card.

10. A clean release card business form comprising:
a web of base material having a top surface and a bottom surface;
a clean release liner affixed on the bottom surface; and
at least one die cut section of the base material web top surface, the at least one die cut section defining a corresponding at least one removable clean release card.

11. A clean release card business form according to claim 10, wherein the base material web comprises a pre-laminated base material.

12. A clean release card business form according to claim 10, wherein the base material web is formed of a material that is suitable for lamination.

13. A clean release card business form according to claim 10, wherein the clean release liner is applied in a continuous press run.

14. A clean release card business form according to claim 10, wherein the clean release material is patched on the bottom surface adjacent the at least one section of the base material web top surface.

15. A clean release card business form according to claim 10, comprising a plurality of die cut sections of the base material web top surface, the plurality of die cut sections defining a corresponding plurality of removable clean release cards.

16. A clean release card business form according to claim 10, wherein at least one of the top surface and the bottom surface is laminated.

17. A clean release card business form according to claim 10, further comprising:
an adhesive disposed on at least one section of the base material web bottom surface to define a corresponding at least one adhesive area, the adhesive area being smaller than and within an area of the clean release card; and
a liner die cut portion formed by die cutting the clean release liner around the adhesive area, wherein when the clean release card is removed from the form, the liner portion of the clean release liner remains attached to the clean release card.

18. A clean release card business form according to claim 10, further comprising indicia printed on at least one of the top surface and the bottom surface.

19. A clean release card form assembled according to the method of claim 1.

20. An identification card mailer assembled according to the method of claim 1.
